(19) United States
(12) Patent Application Publication
(10) Pub. No.: US 2026/0181561 A1
(43) Pub. Date: Jun. 25, 2026

(54) SYSTEMS AND METHODS TO SUPPORT FAST ADAPTATION OF REFERENCE SIGNAL TRANSMISSION

(71) Applicant: InterDigital Patent Holdings, Inc., Wilmington, DE (US)

(72) Inventors: Paul Marinier, Brossard (CA); Moon IL Lee, Melville, NY (US); Ghyslain Pelletier, Montreal (CA); Nazli Khan Beigi, Longueuil (CA); Faris Alfarhan, Montreal (CA)

(73) Assignee: InterDigital Patent Holdings, Inc., Wilmington, DE (US)

(21) Appl. No.: 18/990,542

(22) Filed: Dec. 20, 2024

(51) Int. Cl. H04W 52/32; H04W 52/36

(52) U.S. Cl. CPC H04W 52/325; H04W 52/362; H04W 52/365

(57) ABSTRACT

A wireless transmit/receive unit (WTRU) may be configured for fast adaptation of reference signal (RS) transmission. The WTRU may receive a configuration for RS transmissions. The configuration may indicate one or more conditions and/or resources for requests associated with the RS. The WTRU may, upon the occurrence of an indicated condition send a request to the network to modify, adjust, or cancel one or more RS transmissions. The WTRU may modify, adjust, or cancel the RS transmission based on the occurrence of a condition, or based on receiving a response from the network indicating that the SRS should be modified, adjusted, or cancelled, for example.

### BACKGROUND

Wireless communication systems such as new radio (NR) support WTRU transmission of reference signals (RSs) such as sounding reference signals (SRSs). NR may also support downlink or uplink link adaptation, beam management, and/or positioning (e.g., using positioning reference signals such as SRS for positioning (SRSp)). In NR, the WTRU transmits SRS based on network configuration and/or dynamic indications. The transmission of SRS can recur periodically based on semi-static configuration or dynamic activation. SRS can be transmitted for a single occasion based on a dynamic indication.

### SUMMARY

A wireless transmit/receive unit (WTRU) may receive configuration information comprising a request resource, an associated SRS configuration, and/or an associated power headroom threshold. The WTRU may determine a power headroom (PH) applicable to a PUSCH or an SRS transmission (e.g., a type 1 or type 3 PH) of a carrier of a serving cell.

Under a condition that the power headroom becomes higher or lower than the power headroom threshold, the WTRU may initiate a first transmission on the associated request resource (e.g., a scheduling request resource) at a first transmission power level.

The WTRU may receive a response to the request. The response may include an indication for transmitting SRS with modified parameters. The response may indicate that the SRS should be cancelled. The response may indicate that the SRS should be sent according to the associated SRS configuration. If no response is received before a period has elapsed, the WTRU may initiate retransmission on the associated request resource at a second (e.g., higher) transmission power level.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow call illustrating an example of signaling between a WTRU and a network entity, wherein the WTRU requests an update to a reference signal configuration.

### DETAILED DESCRIPTION

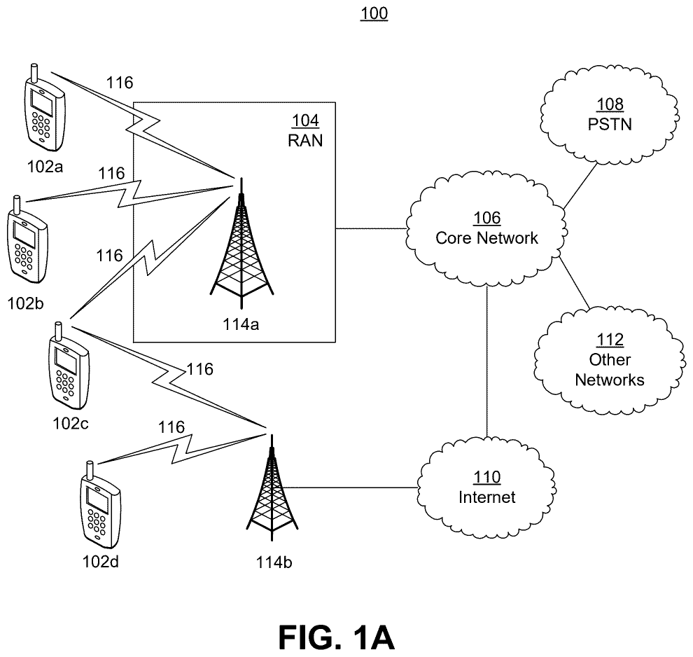

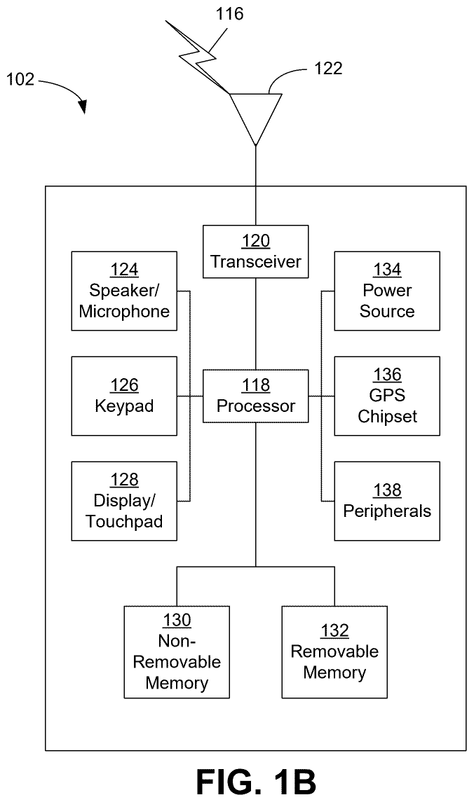

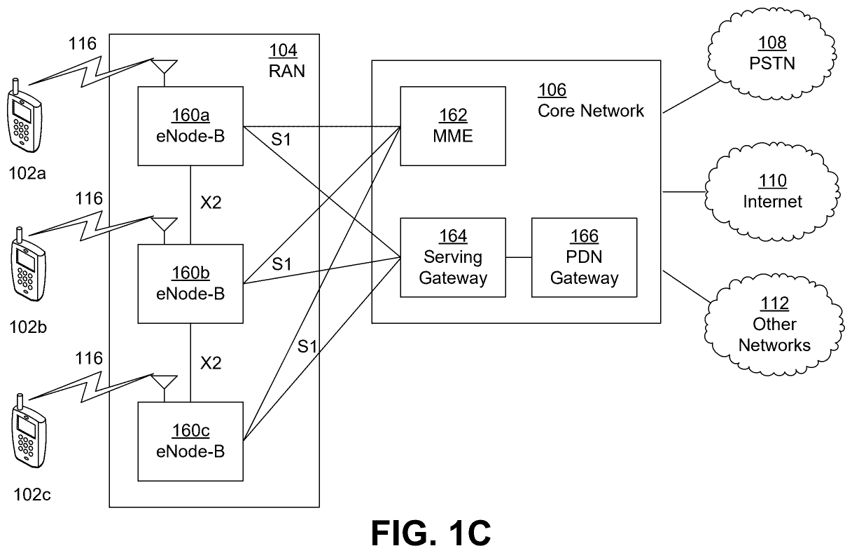

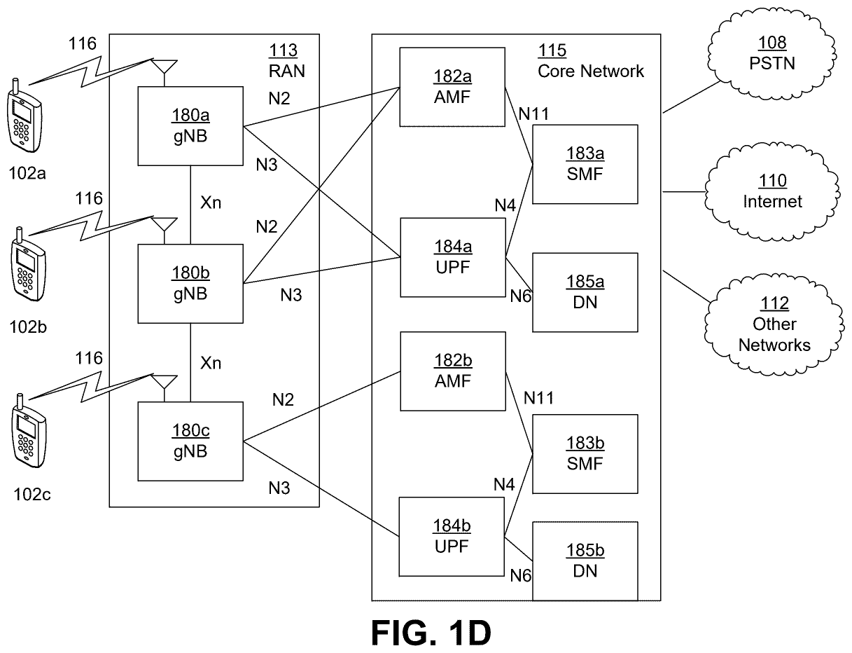

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Initiating (e.g., or stopping, or modifying) sounding reference signal (SRS) transmission may be useful when a condition occurs that is first detectable at the WTRU side. Initiating, stopping, or modifying SRS transmission may be useful when measurement results on reference signal(s) indicate that cell switch should be executed or may happen in the future, or that a cross-link interference situation is potentially occurring. Initiating, stopping, or modifying SRS transmission may be useful when required transmission power of the WTRU becomes lower or higher than a threshold, indicating that SRS-based downlink link adaptation becomes effective (or not effective). Initiating, stopping, or modifying SRS transmission may be useful when uplink data becomes available for transmission.

When such a condition occurs, the WTRU may first send a message to the network (e.g., in a channel state information (CSI) report, power headroom report (PHR) or buffer status report (BSR)). The network may subsequently activate or deactivate a suitable SRS transmission. If no grant is available for transmitting these messages, the period between the time when the condition is satisfied and the time when SRS transmission is initiated or stopped can be long. This may result in performance loss.

Further, there can be a considerable delay from the time that data arrives and the time when the WTRU receives a grant for transmission of a BSR, especially if an SR is transmitted and no grant is available for conveying BSR/PHR. Therefore, by such time, it can be late for the scheduler to request/activate an SRS transmission, and the newly arrived data may be received assuming a less optimal channel estimate.

The embodiments described herein allow for timely adaptation of SRS transmissions, including: initiation or termination of SRS transmissions; and/or adaptation of SRS transmission properties, such as bandwidth, number of symbols, uplink carrier, spatial relation, transmission power, hopping pattern, time pattern, antenna ports, etc.

A wireless transmit/receive unit (WTRU) may receive configuration information comprising a request resource, an associated SRS configuration, and/or an associated power headroom threshold. The WTRU may determine a power headroom (PH) applicable to a PUSCH or an SRS transmission (e.g., a type 1 or type 3 PH) of a carrier of a serving cell.

Under a condition that the power headroom becomes higher or lower than the power headroom threshold, the WTRU may initiate a first transmission as a request on the associated request resource (e.g., a scheduling request resource) at a first transmission power level. The request may be transmitted based on a determination that the PH for the SRS transmission is greater than or less than the PH threshold.

The WTRU may receive a response to the request. The response may include an indication for transmitting SRS with modified parameters. The response may indicate that the SRS should be cancelled. The response may indicate that the SRS should be sent according to the associated SRS configuration. If no response is received before a period has elapsed, the WTRU may initiate retransmission on the associated request resource. In an example, the retransmission may be performed at a second (e.g., higher) transmission power level.

The embodiments described herein enable a WTRU to initiate, stop or adapt transmission of SRS shortly after a condition is met. The embodiments described herein provide a framework for RS adaptation.

Herein, the term “Sounding reference signal” (SRS) may be used to refer to any reference signal transmitted by a WTRU. Thus, for illustrative purposes, the embodiments herein may refer to an SRS or SRS for positioning (SRSp), but it should be understood that other RSs transmitted by a WTRU could also be used. The SRS transmissions, as discussed herein, may be for uplink and/or sidelink.

A WTRU may support one or more SRS configurations. The WTRU may receive configuration information for one or more SRS resource set. For each SRS resource set, the WTRU may receive configuration information for at least one SRS resource.

The configuration information of an SRS resource set may also include one or more of the following information or parameters. The configuration information of an SRS resource set may include a type of resource, indicating how SRS transmission is controlled (e.g. aperiodic based on trigger indicated in DCI, semi-persistent based on activation/de-activation by MAC CE, periodic) and associated parameters (e.g. slot offset, applicable trigger values, associated downlink RS).

The configuration information of an SRS resource set may include an indication of a purpose, such as beam management, codebook or non-codebook based uplink adaptation, antenna switching. The configuration information of an SRS resource set may include one or more power control parameters, for example, alpha, p0, pathloss reference(s), power control adjustment state.

The configuration information of an SRS resource set may indicate how spatial filter is determined (e.g., whether the spatial filter is set according to a spatial relation to a RS of an indicated TCI state or to a configured RS, the serving cell of the configured RS).

The configuration of an SRS resource may include one or more of the following information or parameters. The configuration of an SRS resource may include spatial-domain properties, such as: a number of antenna ports; and/or reference signal or TCI state used as spatial relation for setting spatial filter. The configuration of an SRS resource may include frequency-domain properties, such as: transmission comb parameters, including comb offset hopping if applicable; a frequency-domain position and shift; and/or frequency-hopping parameters.

The configuration of an SRS resource may include time-domain properties, such as: a periodicity, a time offset, a symbol start position, a number of symbols, and/or a repetition factor. The configuration of an SRS resource may include identity of a sequence. The configuration of an SRS resource may include cyclic shift configuration (e.g., group or sequence hopping, and/or hopping parameters).

The WTRU may receive SRS resource configuration information and/or SRS resource set configuration information via RRC signaling and/or MAC signaling. SRS resource configuration information and/or SRS resource set configuration information, or any of the parameters/information included in these configurations, may also be separately configured by bandwidth part, serving cell and/or uplink carrier.

The term “SRS action” (or RS action) may be used to refer to one or more of the following actions. SRS action may refer to triggering, activation, or de-activation of transmission of an SRS resource and/or SRS resource set. SRS action may refer to modification of at least one property of the SRS resource or SRS resource set. In examples, the at least one property may include spatial-domain, frequency-domain, time-domain, sequence, cyclic shift properties, and/or configuration.

The WTRU may initiate SRS action based on reception of network signaling such as DCI or MAC CE. Such is referred to as “network-initiated” SRS action. The network signaling may include information, which may include one or more (e.g., all) of the following parameters.

The network signaling may include an identity of applicable SRS resource set, SRS resource, bandwidth part, serving cell, and/or uplink carrier. The network signaling may include an indication of whether to activate or deactivate the applicable SRS resource set, in case of a semi-persistent SRS resource set. The network signaling may include an indication of a trigger type. Such indication may be useful to handle false-positive detection of an indication by the WTRU. If the trigger type indicates that the network-initiated SRS action is in response to a WTRU indication, the WTRU may perform the SRS action if (e.g., only if) the WTRU has transmitted the indication. If the trigger type indicates that the network-initiated SRS action is in response to a WTRU indication and the WTRU has not transmitted the indication, the WTRU may initiate a procedure to report this event.

Additionally, or alternatively, the WTRU may initiate SRS action based on determining a condition is satisfied. Such is referred to as “WTRU-initiated” SRS action.

Conditions for RS adaptation are considered herein. The WTRU may detect a condition (e.g., or event) that requires adaptation of SRS transmission. Upon detection of the condition, the WTRU may initiate an RS adaptation procedure (or SRS adaptation procedure) which may include at least one of the following actions.

The WTRU may report the condition to the network. The WTRU may transmit an indication or a notification to the network. The WTRU may initiate a procedure to request network to perform SRS action. The WTRU may perform SRS action. Details related to each of above actions are described, in turn, herein. For example, an RS adaptation procedure may include the transmission of a fast adaptation report. For example, an RS adaptation procedure may include an immediate RS adaptation procedure and transmission of associated notification. For example, an RS adaptation procedure may include a request for RS adaptation.

The WTRU may be configured with multiple conditions. Each condition may trigger an RS adaptation procedure. Each such condition may be referred to as an “event”. The WTRU may receive a configuration (e.g., event configuration information) for each event indicating the type of condition and associated parameters. Such a configuration may be identified by an event identifier.

As described in later sections, the WTRU may receive configurations from higher layers for one or more resources for notification, FA report, FA indication or SRS adaptation request, and/or an SRS action. Such a configuration may be referred to as “RS adaptation configuration”. The WTRU may receive an RS adaptation configuration specific to each event and/or to each combination of an event and associated aspect. For example, an associated aspect may include the identity of a downlink reference signal for which a condition is satisfied, or a threshold value used in the configuration of the event. For example, an event may be that a measurement metric for a reference signal becomes above a threshold and the identity of the reference signal may be an associated aspect. In this case, the UE may receive first and second RS adaptation configuration for first and second identity of the reference signal for which the measurement metric becomes above a threshold.

A WTRU may support measurement-based conditions. The WTRU may determine if a set of conditions is satisfied based on a set of measurement results and initiate an RS adaptation procedure if the set of conditions is satisfied. The measurement results may be based on one or more reference signals, such as an SSB or CSI-RS. The measurement results may, additionally or alternatively, be based on one or more resource. The measurement results may include a signal strength or quality metric such as RSRP, SINR, RSRQ, L1-RSRP, L1-SINR, L1-RSRQ, RSSI, and the like. A condition may also be defined based on a quantity derived from a measurement, such as a path loss estimate.

One or more reference signals may be explicitly configured for the event. One or more reference signals may be derived from a TCI state, such as a reference signal configured as the quasi-co-location (QCL) source within the TCI state. The TCI state may be the indicated TCI state or a first or second indicated TCI state. The TCI state may be the TCI state applicable to the SRS resource and/or SRS resource set associated with the event.

Measurement-based conditions may be based on path loss. For example, a condition may be that the path loss or L1-RSRP measured from a reference signal is above or below a configured threshold. A condition can be related to the number of repetitions configured or indicated (e.g., autonomous WTRU retransmissions or TTI bundling) to meet transmission of newly arrived data (e.g. to meet higher reliability with a BLER target lower than a threshold).

Measurement-based conditions may be based on layer 3 (L3), L1/2-triggered mobility (LTM), and/or or WTRU or UE-initiated beam management (UEIBR) events. For example, a condition may correspond to an L3 measurement event, an LTM event or a UEIBR event. One or more associated aspects may be the identity of a reference signal related to the event, a threshold value and/or an offset value configured for the event. For example, an associated aspect may be the reference signal for which measurement result becomes an offset better than a measurement result corresponding to a serving cell or to an indicated TCI state.

Measurement-based conditions may be based on sensing-related events. For example, a condition may be related to a measurement for the purpose of sensing or positioning. The condition may be that a Doppler, RSRP or SINR measurement applicable to a specific path index or delay range of a power delay profile from a sensing reference signal becomes lower or higher than a configured threshold. At least one associated aspect may be the identity of the sensing reference signal, the path index and/or the delay range for which the condition is detected.

Measurement-based conditions may be based on power-based conditions. For example, a condition may be related to a transmission power, a power headroom or a configured maximum power (Pcmax) for WTRU transmission on a serving cell. The condition may be that such quantity is above or below a configured threshold. The condition may be a condition that triggers transmission of power headroom report.

At least one associated aspect may be the type of transmission (PUSCH, PUCCH, SRS), the type of power headroom (e.g. type 1 or type 3), the serving cell, whether the power headroom is configured for two PHR mode and applicable SRS resource set.

Measurement-based conditions may be based on position-based conditions. A condition may be related to a geographic position determined by the WTRU using any positioning method. For example, the condition may be that the WTRU changed its position such that the distance since the last time the event was triggered is higher than a configured threshold. For example, the condition may be that the WTRU enters or leaves a configured area. At least one associated aspect may be the configured area and positioning method.

A WTRU may initiate an RS adaptation procedure based on UL data arrival. The WTRU may initiate an RS adaptation procedure based on meeting a condition for data arrival, including one or more of the following.

The WTRU may initiate an RS adaptation procedure based on the arrival of new uplink data not previously reported at the WTRU buffer. In examples, the WTRU may initiate the RS adaptation procedure if the data meets one of the following conditions.

The WTRU may initiate the RS adaptation procedure if the data is of a certain priority, where the priority is greater than or equal to a configured threshold. The WTRU may determine the priority as a function of the priority of the associated data flow, the LCH priority (e.g., one configured for LCP), and/or a priority index that is passed to the physical layer for the associated data arrival.

The WTRU may initiate the RS adaptation procedure if the data is from a subset of data flow(s) where the data flows are configured. The WTRU may initiate the RS adaptation procedure if the data arrives, that is assigned to a QoS class marker provided by upper layers from a configured subset of QoS classes for transport block (TB) pre-processing/construction. The WTRU may initiate the RS adaptation procedure if the data volume is larger (e.g., or smaller) than a threshold.

In examples, the WTRU may consider the condition met if new data arrives that does not trigger BSR (e.g. due to the priority of the new data arrival being the same or lower priority than priority of data previously reported).

The WTRU may initiate an RS adaptation procedure based on the remaining time for buffered data, possibly from a subset of flows, becoming less than a configured threshold. The remaining time may be determined as the time until the flow's packet delay budget (PDB) is exhausted or the time until the discard timer associated with the packet expires (e.g., where such timer may be maintained at higher layers, e.g. PDCP).

The WTRU may initiate an RS adaptation procedure based on a new buffer status report (e.g. BSR) being triggered. For example, the WTRU may initiate the RS adaptation procedure if (e.g., only if) the BSR is triggered by data arrival from a subset of data flows or of a certain priority.

The WTRU may initiate an RS adaptation procedure based on a new delay status report (DSR) being triggered. For example, the WTRU may initiate the RS adaptation procedure if (e.g., only if) the DSR is triggered by data from a subset of data flows, where the DSR reports remaining time associated with one or more data flows or of a certain priority.

The WTRU may initiate an RS adaptation procedure based on a new scheduling request (SR) being triggered. For example, the WTRU may initiate the RS adaptation procedure if (e.g., only if) the BSR/DSR is triggered by data arrival from a subset of data flows or of a certain priority.

The WTRU may initiate an RS adaptation procedure based on the triggering of one or more (e.g., high priority) MAC CEs for transmission. For example, the WTRU may initiate the RS adaptation procedure upon a MAC CE of a certain type or priority being triggered (e.g. a MAC CE that has a higher priority than other data in the LCP procedure, one that is of the same priority as PHR or higher, or a control type MAC CE).

The WTRU may initiate an RS adaptation procedure based on the reception of DL data of a certain data flow that is associated with an uplink data flow (e.g. one that is configured with reflective QoS). Receiving the DL data may trigger UL data transmission and/or may trigger the WTRU to initiate an RS adaptation procedure.

A WTRU may initiate an RS adaptation procedure based on downlink data arrival and/or paging. The WTRU may initiate an RS adaptation procedure based on meeting a condition for downlink data arrival and/or paging, including one or more of the following.

The WTRU may initiate an RS adaptation procedure based on the reception of PDCCH indicating PDSCH (e.g. downlink data), possibly if a period has elapsed since last reception of PDSCH and/or transmission of PUSCH. The WTRU may initiate an RS adaptation procedure based on the reception of PDSCH, possibly according to a semi-persistent scheduling assignment. The WTRU may initiate an RS adaptation procedure based on the reception of a paging indication for mobile-terminated small data transmission. At least one associated aspect for events related to downlink data arrival and/or paging may include information provided in the PDCCH or in the paging indication. For example, the paging indication may include an index referring to an RS adaptation configuration, or of a SRS resource identity or SRS resource set identity to be activated following reception of the PDCCH, PDSCH or paging indication.

A WTRU may comprise one or more CSI processing units. A WTRU may determine, be configured, and/or indicated to calculate, evaluate, measure, estimate, indicate, and/or report the number of occupied CPUs. The WTRU may calculate the number of occupied CPUs for CSI reporting. That is, the WTRU may be configured with one or more CSI report configurations, based on which the WTRU may calculate and report the CPU occupancy.

Example methods for calculating the CPU occupancy are provided herein. These examples are non-limiting examples. A WTRU may be configured with CPU occupancy configurations and parameters. One or more of those configurations/parameters may be included. Other configurations may be included.

The WTRU may indicates a number of supported simultaneous CSI calculations N_{CPU} (e.g., using parameter simultaneousCSI-ReportsPerCC in a component carrier, or simultaneous CSI-ReportsAllCC across all component carriers). If a WTRU supports N_{CPU} simultaneous CSI calculations it is said to have N_{CPU} CSI processing units for processing CSI reports. If L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to O_{CPU}⁽ⁿ⁾, the WTRU may not be required to update the N−M requested CSI reports with lowest priority, where 0≤M≤N is the largest value such that Σₙ₌₀^{M-1}O_{CPU}⁽ⁿ⁾≤N_{CPU}−L holds.

The CPU(s) may be occupied for a number of OFDM symbols. In examples, for a CSI report with CSI-ReportConfig with higher layer parameter reportQuantity not set to ‘none’, the CPU(s) may be occupied for a number of OFDM symbols as described herein.

A periodic or semi-persistent CSI report may occupy the CPU(s) for one or more OFDM symbols. In examples, a periodic or semi-persistent CSI report (e.g., excluding an initial semi-persistent CSI report on PUSCH after the PDCCH triggering the report and a semi-persistent CSI report on PUSCH configured with the higher layer parameter codebookType set to ‘typeII-Doppler-r18’ or ‘typeII-Doppler-PortSelection-r18’) may occupy CPU(s) from the first symbol of the earliest one of each CSI-RS/CSI-IM/SSB resource, or each CSI-RS/CSI-IM resource associated with all configured sub-configurations for periodic CSI report corresponding to a CSI-ReportConfig that contains a list of sub-configurations provided by csi-ReportSubConfigList, or each CSI-RS/CSI-IM resource associated with all triggered sub-configurations for semi-persistent CSI report corresponding to a CSI-ReportConfig that contains a list of sub-configurations provided by csi-ReportSubConfigList, for channel or interference measurement, respective latest CSI-RS/CSI-IM/SSB occasion no later than the corresponding CSI reference resource, until the last symbol of the configured PUSCH/PUCCH carrying the report.

The CPUs may be occupied by an aperiodic CSI report. In examples, an aperiodic CSI report may occupy CPU(s) from the first symbol after the PDCCH triggering the CSI report until the last symbol of the scheduled PUSCH carrying the report. When the PDCCH reception includes two PDCCH candidates from two respective search space sets for the purpose of determining the CPU occupation duration, the PDCCH candidate that ends later in time may be used.

In examples, an initial semi-persistent CSI report on PUSCH after the PDCCH trigger may occupy CPU(s) from the first symbol after the PDCCH until the last symbol of the scheduled PUSCH carrying the report. When the PDCCH reception includes two PDCCH candidates from two respective search space sets for the purpose of determining the CPU occupation duration, the PDCCH candidate that ends later in time may be used.

The CPUs may be occupied by a semi-persistent CSI report. In examples, a semi-persistent CSI report on PUSCH configured with the higher layer parameter codebookType set to ‘typeII-Doppler-r18’ or ‘typeII-Doppler-PortSelection-r18’ may occupy CPU(s) from the first symbol of K_{P}-th latest consecutive periodic/semi-persistent CSI-RS occasions no later than CSI reference resource, until the last symbol of the PUSCH carrying the report, where the value of K_{P}∈{1,2,4} is indicated by WTRU capability.

For a CSI report with CSI-ReportConfig with higher layer parameter reportQuantity set to ‘none’ and CSI-RS-ResourceSet with higher layer parameter trs-Info not configured, the CPU(s) may be occupied for a number of OFDM symbols as described herein.

In examples, a semi-persistent CSI report (e.g., excluding an initial semi-persistent CSI report on PUSCH after the PDCCH triggering the report) may occupy CPU(s) from the first symbol of the earliest one of each transmission occasion of periodic or semi-persistent CSI-RS/SSB resource for channel measurement for L1-RSRP computation, until

$${Z}_{3}^{′}$$

symbols after the last symbol of the latest one of the CSI-RS/SSB resource for channel measurement for L1-RSRP computation in each transmission occasion.

The CPUs may be occupied by an aperiodic CSI report. An aperiodic CSI report may occupy CPU(s) from the first symbol after the PDCCH triggering the CSI report until the last symbol between Z₃ symbols after the first symbol after the PDCCH triggering the CSI report and

$${Z}_{3}^{′}$$

symbols after the last symbol of the latest one of each CSI-RS/SSB resource for channel measurement for L1-RSRP computation. Z₃ and

$${Z}_{3}^{′}$$

may be as defined in Table 1.

TABLE 1
Example of CSI computation delay requirements

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, | X₂ |
| | | | | | X₂ + KB₁) | |
| 3 | 97 | 85 | 152 | 140 | min(97, | X₃ |
| | | | | | X₃ + KB₂) | |
| 5 | 388 | 340 | 608 | 560 | min(388, | X5 |
| | | | | | X5 + KB3) | |
| 6 | 776 | 680 | 1216 | 1120 | min(776, | X6 |
| | | | | | X6 + KB4) | |

Cellular systems may use priority rules for CSI reports. Priority rules may be indicated for CSI reports. Example methods for calculating priority values for CSI reports are described herein. These examples are non-limiting examples. These examples may include or involve one or more priority configurations and/or parameters. These configurations/parameters are exemplary. Other configurations may be included.

The CSI reports may be associated with a priority value, (e.g., Pri_{iCSI}(y,k,c,s)=2·N_{cells}·Mₛ·y+N_{cells}·Mₛ·k+Mₛ·c+s). The value of y may be set to 0 for aperiodic CSI reports to be carried on PUSCH. The value of y may be set to 1 for semi-persistent CSI reports to be carried on PUSCH. The value of y may be set to 2 for semi-persistent CSI reports to be carried on PUCCH. The value of y may be set to 3 for periodic CSI reports to be carried on PUCCH. The value of k may be set to 0 for CSI reports carrying L1-RSRP or L1-SINR. The value of k may be set to 1 for CSI reports not carrying L1-RSRP or L1-SINR. The parameter c is the serving cell index and the parameter N_{cells} is the value of the higher layer parameter maxNrofServingCells.

For a CSI report configured with LTM-CSI-ReportConfig, c may be set to the serving cell index value where the report configuration is configured. The parameter s is the reportConfigID. The value of s may be set to the value of the higher layer parameter maxNrofCSI-ReportConfigurations. For a CSI report configured with LTM-CSI-ReportConfig, s may be equal to the LTM-CSI-ReportConfigID. Ms may be equal to the value of the higher layer parameter maxNrofLTM-CSI-ReportConfigurations.

A first CSI report is said to have priority over second CSI report if the associated Pri_{iCSI}(y,k,c,s) value is lower for the first report than for the second report.

A WTRU may determine, be configured, and/or indicated to initiate an RS adaptation procedure based on the calculated CPU occupancy and/or one or more conditions. For example, the WTRU may receive configuration information and/or one or more indications. The configuration information and/or indications may include one or more threshold values. The configuration information and/or indications may be sent, for example, via SIB, RRC, MAC-CE, DCI, etc. In an example, the WTRU may be configured with one or more thresholds on the CPU occupancy. In examples, the WTRU may be configured with one or more CSI report configurations. The WTRU may calculate the CPU occupancy based on the one or more CSI report configurations. In examples, the WTRU may calculate the priority values for one or more of the configured CSI report configurations. For example, the WTRU may be configured with one or more thresholds on the CSI report priority levels.

In examples, the WTRU may determine to initiate an RS adaptation procedure, where the SRS transmission or RS adaptation configuration is associated with one or more of the configured CSI report configurations. For example, the WTRU may be configured with a first CSI report configuration and a second CSI report configuration. In examples, the WTRU may determine to perform CSI measurements and transmit the configured CSI report based on the first CSI report configuration. In examples, the WTRU may determine to skip CSI measurements and drop the configured CSI report based on the second CSI report configuration, due to one or more determined conditions. Instead, the WTRU may initiate one or more SRS transmissions associated with the second CSI report configuration. In examples, the WTRU may send one or more SRSs based on one or more CSI resources configured in the second CSI report configuration. For example, the WTRU may use the UL TCI-state associated with and/or in correspondence with the DL TCI-states configured for one or more CSI resources configured in the second CSI report configuration.

In examples, the WTRU may determine to initiate an RS adaptation procedure associated with one or more of the configured CSI report configurations, based on one or more of the following example conditions.

The WTRU may initiate an RS adaptation procedure based on a condition relating to CSI priority levels. For example, the WTRU may determine, be configured, and/or indicated to initiate RS adaptation procedure for CSI report configurations with low priority. The WTRU may calculate the priority level for the configured CSI report configurations. In examples), the WTRU may initiate the SRS transmission associated with the first CSI report configuration if a first measured priority level for a first CSI report configuration is higher than a determined, indicated, and/or configured priority-threshold (e.g., if the first CSI report has low priority). In examples, the WTRU may continue with CSI measurement and transmitting CSI reports associated with the second CSI report configuration if a second measured priority level for a second CSI report configuration is lower than the priority-threshold (e.g., if the second CSI report has high priority.

In examples, the WTRU may determine, be configured, and/or indicated to initiate RS adaptation procedure for CSI report configurations with high priority. The WTRU may calculate the priority level for the configured CSI report configurations. In examples, the WTRU may continue with CSI measurement and transmitting CSI reports associated with the first CSI report configuration if a first measured priority level for a first CSI report configuration is higher than a determined, indicated, and/or configured priority-threshold. In examples, the WTRU may initiate the SRS transmission associated with the second CSI report configuration if a second measured priority level for a second CSI report configuration is lower than the priority-threshold. The priority levels may be indicated, for example, by numerical values.

The WTRU may initiate an RS adaptation procedure based on a condition relating to CPU occupancy. For example, the WTRU may determine, be configured, and/or indicated to initiate RS adaptation procedure if the calculated CPU occupancy is higher than a corresponding determined, indicated, and/or configured occupancy-threshold. The WTRU may calculate the CPU occupancy for one or more configured CSI report configurations. The WTRU may initiate the RS adaptation procedure if the calculated CPU occupancy is higher than the corresponding occupancy-threshold.

The WTRU may initiate an RS adaptation procedure based on a condition relating to a combination of priority level and CPU occupancy. For example, the WTRU may determine, be configured, and/or indicated to initiate RS adaptation procedure for CSI report configurations based on the joint evaluation of the priority level and CPU occupancy. In examples, the WTRU may determine to continue with measuring CSI and reporting one or more CSI report configurations based on priority levels. In examples, the WTRU may determine, be configured, and/or indicated to initiate RS adaptation procedures associated with CSI report configurations with the highest priority (e.g., calculated priority lower than a threshold). In examples, the WTRU may determine, be configured, and/or indicated to initiate RS adaptation procedures associated with CSI report configurations with the lowest priority (e.g., calculated priority higher than a threshold).

In examples, if the measurements at the NW based on the SRS are accurate enough (e.g., based on an accuracy calculation), the WTRU may select to initiate RS adaptation procedures associated with high priority CSI reports. However, if the measurements at the NW based on the SRS are not accurate enough (e.g., based on an accuracy calculation), the WTRU may select to continue to measure CSI and report for the high priority CSI reports.

In examples, for the remaining configured CSI report configurations, the WTRU may determine to continue measuring and/or reporting or instead initiating an RS adaptation procedure based on the calculated CPU occupancy. If the calculated CPU occupancy is higher than a corresponding determined, indicated, and/or configured occupancy-threshold, the WTRU may initiate RS adaptation procedures associated with the remaining CSI report configurations. In examples, if the calculated CPU occupancy is lower than the corresponding occupancy-threshold, the WTRU may continue measuring and reporting based on the configured CSI report configurations (e.g., and so forth).

WTRU power consumption states are considered herein. A network energy saving (NES) state or an availability state may refer to a cell state in which the cell or TRP has activated at least one NES technique. Examples of NES techniques include: reduced SIB1 transmission (e.g., periodic or existence), reduced SSB transmission (e.g., periodic or existence), cell DTX, cell DRX, spatial domain adaptation (e.g., where a subset of antenna ports and/or elements are turned off), power domain adaptation (e.g., where a subset of channels are transmitted with reduced power or muted), and/or turning off the cell or TRP. A WTRU power saving state may similarly correspond to a state during which the WTRU is reducing its PDCCH monitoring, active DRX or cell DTX/DRX, using a reduced number of antenna elements or TRPs, or in a dormant state.

The WTRU may determine whether to initiate an RS adaptation procedure depending on a network NES state or a WTRU power saving state. In a sleep pattern, the active period may correspond to the time when the NW may actively transmit DL signals/channels and/or the time when the NW may blind decode for UL signals/channels. The WTRU may adjust or modify one or more properties of the SRS transmission as a function of the WTRU power saving state, the cell's NES state, and/or whether the WTRU is in the active period or the non-active period of a cell discontinuous transmission (DTX)/discontinuous reception (DRX) pattern. The WTRU may use a different SRS configuration than in its normal state when the cell or WTRU are in a NES state or a power saving state.

In examples, the WTRU may initiate an RS adaptation procedure upon receiving signaling (e.g., by L1/L2/RRC/SI signaling) that deactivates a NES state and/or a WTRU power saving state. The WTRU may initiate an RS adaptation procedure upon transitioning from power savings to normal state. The WTRU may initiate an RS adaptation procedure upon reception of a low power signal including a LP-WUS or a LP-SSB, or upon reception of signaling that activates a NES state or a power saving state.

Control plane procedure-related conditions are considered herein. The WTRU may initiate an RS adaptation procedure based on meeting a condition related to control plane procedures used in higher layers, including any one or more of the following procedures.

The WTRU may initiate an RS adaptation procedure based on meeting a condition related to cell switching (e.g., by command or conditional). For example, the WTRU may initiate an RS adaptation procedure upon meeting a condition for conditional cell switch or conditional handover, or upon reception of a handover command (e.g. RRC reconfiguration or L1/L3 mobility signaling). The WTRU may initiate an RS adaptation procedure at the source cell, target cell, or both cells. In examples, the WTRU's initiation of the RS adaptation procedure may be dependent on whether a configured grant is used for RACH-less handover at the target cell upon reception of an L1/L2 handover command.

The WTRU may initiate an RS adaptation procedure based on meeting a condition related to RRC connection setup. The WTRU may initiate an RS adaptation procedure upon triggering one or more RRC procedures, including: RRC (re)-establishment, RRC resume, and/or RRC suspend. In examples, the WTRU may initiate an RS adaptation procedure upon transmission of an RRC resume or upon receiving a command from the NW in response (e.g., an RRC admit message or a command to transition to connected mode).

The WTRU may initiate an RS adaptation procedure based on meeting a condition related to BWP switching. The WTRU may initiate an RS adaptation procedure upon switching to a given BWP, which may be preconfigured, or upon reception of a BWP switch command. The BWP switch indication may provide an indication to apply a specific SRS transmission configuration/assumption and/or to whether the WTRU should initiate an RS adaptation procedure.

The WTRU may initiate an RS adaptation procedure based on meeting a condition related to Scell activation/deactivation. The WTRU may initiate an RS adaptation procedure upon reception of an SCell activation/deactivation command. For example, the Scell (de)-activation MAC CE (e.g., or a related new MAC CE) can provide an indication that the WTRU should apply a specific SRS transmission configuration/assumption and/or whether the WTRU should initiate an RS adaptation procedure.

The WTRU may initiate an RS adaptation procedure based on meeting a condition related to reception of an on-demand SSB or a related indication for an (de)-activation of on-demand SSB. The WTRU may initiate an RS adaptation procedure upon reception of such an indication (e.g., via MAC CE). In examples, the MAC CE can indicate an RS adaptation procedure or assumption. The WTRU may transmit SRS for a number of occasions in line with the on-demand-synchronization signal block (OD-SSB) transmission occasions (e.g., N times) or until an associated SCell is activated or deactivated.

The WTRU may initiate an RS adaptation procedure based on meeting a condition related to beam failure recovery (BFR). Upon transmission of a request for BFR, WTRU may initiate an RS adaptation procedure. The RS adaptation procedure can be dependent on the “best beam/SSB” selected by that WTRU/indicated part of the BFR MAC CE.

The WTRU may initiate an RS adaptation procedure based on meeting a condition related to beam failure detection (BFD). The WTRU may initiate an RS adaptation procedure upon detecting that the BFD counter is larger than a configured threshold. The WTRU may initiate an RS adaptation procedure if measurements associated with BFD-RS are lower than a configured threshold.

The WTRU may initiate an RS adaptation procedure based on meeting a condition related to radio link monitoring (RLM). WTRU may initiate an RS adaptation procedure while a timer (e.g., T310) is running. WTRU may initiate another RS adaptation procedure while a timer (e.g., T311) is running. WTRU may initiate a third RS adaptation procedure upon declaring radio link failure (RLF). The WTRU may perform RRC re-establishment and/or may initiate an RS adaptation procedure based on performing RRC re-establishment.

The WTRU may initiate an RS adaptation procedure based on meeting a condition related to detecting an LBT failure or a consistent LBT failure. The WTRU may initiate an RS adaptation procedure based on meeting a condition related to RRC Re-establishment. The WTRU may initiate an RS adaptation procedure during an RRC re-establishment procedure (e.g. in connected mode).

The WTRU may initiate an RS adaptation procedure based on meeting a condition during random access. For example, the WTRU may initiate an RS adaptation procedure based on receiving a random access response (RAR). The WTRU may initiate an RS adaptation procedure upon retransmitting a Msg3. The WTRU may initiate an RS adaptation procedure upon transmitting a MsgA (e.g., combined preamble and data). The WTRU may initiate an RS adaptation procedure upon receiving an indication of a RAR and/or a MsgB (e.g., possibly an indication an SRS action or assumption). The WTRU may initiate an RS adaptation procedure upon receiving a backoff indication (e.g., in such case WTRU can reduce or deactivate SRS transmission/action).

Fast adaptation reporting and indications are considered herein. The WTRU may initiate transmission of a report or indication when a condition or a combination of conditions is/are satisfied (e.g., as discussed above). Such a report or indication may be referred to as a “Fast adaptation (FA) report” or “Fast adaptation (FA) indication” herein. The FA report or FA indication may be useful for the network to dynamically adapt some aspect of the WTRU configuration including but not limited to SRS transmission. An RS adaptation procedure may include transmission of an FA report or FA indication.

A WTRU may create a container (e.g., a MAC control element) for a FA report or indication. An FA report or FA indication may be included in a MAC control element (MAC CE). The MAC CE can be a MAC CE specifically defined for the purpose of FA report. Additionally, or alternatively, the MAC CE can be an existing MAC CE such as a MAC CE containing a power headroom report (PHR). The MAC CE can be an extension of an existing MAC CE.

An FA report or FA indication may be carried as Layer 1 uplink control information (UCI) over PUCCH or PUSCH. For example, an FA indication may be carried by an SR resource (e.g. PUCCH format 0). In examples, an FA report may be carried by a multi-bit PUCCH format or as UCI multiplexed in PUSCH, possibly as a type of channel state information (CSI).

Procedures for transmitting an FA report or indication are considered herein. When transmission of FA report or indication is triggered, the WTRU may use one or more of following embodiments to perform transmission.

The WTRU may receive configuration information or an indication of at least one resource for the transmission of the FA report or indication. For example, the WTRU may receive configuration information for a periodic PUCCH resource (e.g., a SR resource or multi-bit resource). The WTRU may encode a field for an FA indication with a first value (e.g., zero (0) if the FA indication is not triggered and a second value (e.g., one (1) if the FA indication is triggered. The WTRU may also omit transmission on a resource when no FA report is triggered.

The resource may be associated with one or more events or event identifiers. For example, the WTRU may use a first resource for the transmission of FA indication triggered by path loss becoming lower than a first configured threshold. The WTRU may use a second resource for the transmission of FA indication triggered by path loss becoming higher than a first configured threshold. The WTRU may use a third resource for the transmission of FA indication triggered by the WTRU moving in or out of an area, and so on. The WTRU may determine the resource associated with a trigger and/or parameters from higher layer signaling. In case the event corresponds to a cell switch or bandwidth part switch, the resource may be configured in the target cell or target bandwidth part.

If the FA report is carried by MAC CE, the WTRU may multiplex the MAC CE in a transport block of an available grant. If there is no available grant for transmission, the WTRU may initiate a procedure to request a grant for transmission of the MAC CE. For example, the WTRU may trigger a scheduling request (SR) and/or cancel a pending SR upon transmission of a MAC protocol data unit (PDU) comprising the MAC CE for the FA report. The WTRU may receive configuration information for the SR for the request of grant for FA reporting via higher layer signaling.

Alternatively, or additionally, the WTRU may initiate a random access procedure and include the FA report in the random access response grant or a subsequent grant. The WTRU may also include the FA report in msgA transmission for a 2-step random access procedure. In examples, the WTRU may initiate random access procedure under a condition that an applicable timing advance timer is not running.

The contents of an FA report or indication are considered herein. The WTRU may include at least one of the following pieces of information in the FA report. The WTRU may include, in the FA report, an indication of the event or condition(s) that triggered the transmission of this FA report. The WTRU may include, in the FA report, at least one value related to the condition that triggered the transmission of this FA report, such as the identity of a reference signal, TCI state, or the value of a measurement.

A WTRU may support immediate RS adaptation with notification. The WTRU may perform SRS action (e.g., without explicit indication from network) when a condition or a combination of conditions are satisfied (e.g., as discussed above). Such a procedure may be referred to as “immediate RS adaptation”. The WTRU may also initiate transmission of an associated notification, either before or after the WTRU performs the SRS action. Such a notification may be transmitted using the same resources as discussed herein in for the transmission of an FA indication or report. An RS adaptation procedure may include at least one of immediate RS adaptation and transmission of associated notification.

The WTRU may be configured by higher layers with an association between a resource used for the transmission of a notification and an event. The notification may include information as described herein for the FA report. The notification may comprise information on the SRS action performed (e.g., or to be performed) by the WTRU, such as activation, deactivation, modification of parameter, SRS identity, and/or the like.

The notification may comprise a WTRU identity. Including the WTRU identity may be beneficial if the network configures more than one WTRU with the same SRS resource or resource set for the SRS action (e.g., to help the network identify the WTRU sending the notification).

The notification may comprise information indicating the timing of the SRS action. The timing may be expressed relative to the timing of the transmission of the notification or in terms of system timing (e.g. system frame number, slot number).

In examples, the WTRU may first initiate transmission of the notification and perform the SRS action at a specific time after the transmission of the notification. The time may be a pre-defined or configured duration after a first or last symbol of the resource on which the notification is transmitted. Additionally, or alternatively, the WTRU may perform the SRS action at a specific time after the event is triggered and transmit the notification no later than a maximum duration following the SRS action or the triggering of the event. The WTRU may revert the SRS action if it has not transmitted the notification after the maximum time.

The WTRU may associate an SRS action with a specific event. The WTRU may receive configuration from higher layers (e.g. MAC or RRC) indicating SRS action(s) and associated parameters for at least one event. In an example, the WTRU may be configured with a set of events and a set of SRS actions as follows: Event #1: Pathloss becomes higher than X1 dB, Event #2: Pathloss becomes higher than X2 dB, Event #3: Pathloss becomes lower than Y dB, Event #4: WTRU detects CSI-RS #53 with RSRP larger than Z dB, [ . . . ] (etc.); and SRS action #1: Deactivate SRS resource set #1, Activate SRS resource set #2, SRS action #2: Deactivate SRS resource set #2, SRS action #3: Modify resource mapping for SRS resource #3 (or SRS resources of SRS resource set #3) to a certain value, SRS action #4: Activate SRS resource set #4, [ . . . ] (etc.).

The WTRU may receive configuration associating, for example, SRS action #1 to event #1, SRS action #2 or SRS action #3 to event #2, SRS action #4 to event #4, etc.

An event may be configured for “report on leave” such that the WTRU triggers a report when the condition defined by the event is no longer satisfied. The WTRU may receive configuration associating first and second SRS actions to entering and leaving a condition, respectively.

Requests for RS adaptation are discussed herein. The WTRU may initiate a procedure to request an SRS action when a condition or a combination of conditions are satisfied (e.g., as discussed above). Such a procedure may be referred to as a “request for RS adaptation”. An RS adaptation procedure may include a request for RS adaptation procedure.

The WTRU may first transmit an RS adaptation request. The WTRU may subsequently receive signaling indicating an SRS action satisfying certain conditions as described herein. Such an SRS action may be referred to as a “corresponding SRS action”. If the WTRU has not received the corresponding SRS action before a period of time after the transmission of a first RS adaptation request, the WTRU may transmit a second RS adaptation request (e.g., possibly with a higher power level). The WTRU may transmit additional RS adaptation request(s) until the signaling for corresponding SRS actions is received, or until a configured maximum number of RS adaptation requests are transmitted.

An RS adaptation request may be included in a scheduling request (SR). In this case, the WTRU may follow an SR procedure where the WTRU cancels a pending SR upon reception of a corresponding SRS action.

The WTRU may initiate a random access procedure to perform an RS adaptation request. In examples, the WTRU may initiate random access to perform an RS adaptation request under a condition that an applicable timing advance timer is not running.

The WTRU may be configured by higher layers with an association between an event (e.g., including associated parameters) and a resource used for the transmission of a request (e.g., such as SRS resource) and/or an SR configuration. The WTRU may use the SR configuration or resource associated with the event that triggered the procedure to transmit the RS adaptation request. The WTRU may be further configured with an association between an event and an SRS action (e.g., as described herein) and/or with an association between the SRS resource or SR configuration and an SRS action.

Conditions for corresponding SRS action are discussed herein. In examples, the WTRU may determine that any signaling for an SRS action meets a condition for corresponding SRS action. Alternatively, or additionally, the WTRU may determine if signaling including an SRS action is a corresponding SRS action based on at least one of the following conditions.

The UE may determine if signaling including an SRS action is a corresponding SRS action based on an SRS action included in the signaling matching an SRS action associated to the event that triggered the RS adaptation request or to the resource used for the transmission of the RS adaptation request. A match may be determined based on whether for at least one of the following aspects of an SRS action included in the signaling matches that of the SRS action associated to the event.

The WTRU may determine a match based on the SRS action associated to the event matching an identity or tag associated to the SRS action. The WTRU may determine a match based on the SRS action associated to the event matching an identity of the SRS resource or SRS resource set subject to the SRS action. The WTRU may determine a match based on the SRS action associated to the event matching a parameter of the SRS resource or SRS resource set subject to the SRS action. The WTRU may determine a match based on the SRS action associated to the event matching a type of action (e.g. activation, de-activation, modification). The WTRU may determine a match based on the SRS action associated to the event matching a type of signaling (e.g. MAC or DCI) for the SRS action.

The WTRU may determine if signaling including an SRS action is a corresponding SRS action based on the signaling including the identity of a resource or of a scheduling request for RS adaptation request. This identity may match the one used for the transmission of RS adaptation request.

The WTRU may determine if signaling including an SRS action is a corresponding SRS action based on the signaling including the identity of an event. This event identity may match the event that triggered the RS adaptation request.

A WTRU may confirm corresponding SRS actions. If the WTRU transmits an RS adaptation request and then receives signaling for a corresponding SRS action, the WTRU may transmit a confirmation and follow the SRS action indicated in the signaling. The WTRU may transmit the confirmation using uplink control signaling or MAC control element. The WTRU may receive configuration of a resource for this purpose from higher layer signaling. The WTRU may follow the indicated SRS action upon reception of the signaling indicating the SRS action. Additionally, or alternatively, the WTRU may follow the indicated SRS action after a period following the first or last symbol of the resource containing the confirmation.

The WTRU may receive non-corresponding SRS actions. The WTRU may receive signaling for an SRS action that includes the identity of a resource or of a scheduling request for RS adaptation request. If the WTRU has not transmitted an RS adaptation request using a resource or a scheduling request that matches this identity within a period preceding the reception of the signaling, the WTRU may determine that the SRS action was sent due to false detection of an RS adaptation request. Similarly, the WTRU may receive signaling for an SRS action that includes the identity of an event. If the WTRU has not transmitted an RS adaptation request triggered by the identified event, the WTRU may determine that the SRS action was sent due to false detection of an RS adaptation request.

If the WTRU determines that the SRS action was sent due to false detection, the WTRU may perform at least one of the following actions. The WTRU may transmit a report notifying the network that no RS adaptation request corresponding to the received SRS action was transmitted. The WTRU may transmit the report using a MAC control element or as uplink control information. The WTRU may receive configuration of a resource for this purpose from higher layer signaling. The WTRU may ignore the SRS action signaled by the network. Additionally, or alternatively, the WTRU may follow the SRS action irrespective of whether it determined that it was sent due to false detection or not. The WTRU may initiate transmission of an RS adaptation request for reversing a false detection. In other words, the determination that an SRS action was sent due to false detection may be an event that triggers an RS adaptation request. The WTRU may receive configuration of a resource used for the transmission of a request and/or an SR configuration associated (e.g., as for any other event).

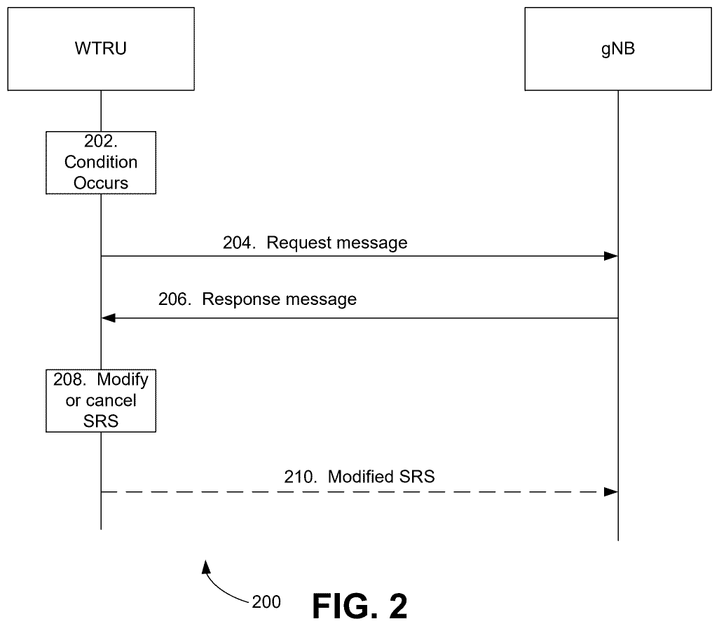

FIG. 2 is a flow call showing a simplified example of signaling in an embodiment at 200. The WTRU may be configured to perform SRS transmission. The configuration for SRS transmission may include a request resource. At 202, the WTRU may detect that a condition has occurred. At 204, the WTRU may send a request message to a network entity (e.g., gNB) using the request resource associated with the configuration for SRS transmission. At 206, the WTRU may receive a response message from the network entity. Based on receiving the response message, at 208, the WTRU may determine to modify or cancel future SRS transmissions. At 210 (e.g., if SRS transmissions have not been cancelled) the WTRU may transmit SRS, as modified based on the response message.

1. A wireless transmit/receive unit (WTRU) comprising
a processor and memory, wherein the processor and memory are configured to:
receive configuration information for sounding reference signal (SRS) transmission, the configuration information comprising a power headroom (PH) threshold and an indication of a request resource;
determine a PH for an SRS transmission;
send a request message using the request resource based on determining that the PH for the SRS transmission is greater than or less than the PH threshold;
receive a response to the request message, wherein the response comprises an indication that one or more transmission parameters associated with the SRS transmission are to be modified.

2. The WTRU of claim 1, wherein the processor and memory are further configured to:
send the SRS transmission using the one or more transmission parameters, wherein the one or more transmission parameters are modified in accordance with the indication comprised in the response.

3. The WTRU of claim 1, wherein the processor and memory are further configured to:
cancel the SRS transmission, based on an indication in the one or more transmission parameters, wherein the one or more transmission parameters are modified in accordance with the indication comprised in the response.

4. The WTRU of claim 1, wherein the request message comprises a scheduling request.

5. The WTRU of claim 1, wherein the processor and memory are configured to: determine a type 1 PH or a type 3 PH for the SRS transmission.

6. The WTRU of claim 1, wherein the processor and memory are further configured to:
resend the request message, based on determining that no response has been received within a period of time after the request message is sent.

7. The WTRU of claim 6, wherein the processor and memory are further configured to:
send the request message using a first power level; and
resend the request message using a second power level, wherein the second power level is higher than the first power level.

8. A method to be performed by a wireless transmit/receive unit (WTRU), the method comprising:
receiving configuration information for sounding reference signal (SRS) transmission, the configuration information comprising a power headroom (PH) threshold and an indication of a request resource;
determining a PH for an SRS transmission;
sending a request message using the request resource based on determining that the PH for the SRS transmission is greater than or less than the PH threshold;
receiving a response to the request message, wherein the response comprises an indication that one or more transmission parameters associated with the SRS transmission are to be modified.

9. The method of claim 8, further comprising:
sending the SRS transmission using the one or more transmission parameters, wherein the one or more transmission parameters are modified in accordance with the indication comprised in the response.

10. The method of claim 8, further comprising:
canceling the SRS transmission, based on an indication in the one or more transmission parameters, wherein the one or more transmission parameters are modified in accordance with the indication comprised in the response.

11. The method of claim 8, wherein the request message comprises a scheduling request.

12. The method of claim 8, further comprising:
determining a type 1 PH or a type 3 PH for the SRS transmission.

13. The method of claim 8, further comprising:
resending the request message, based on determining that no response has been received within a period of time after the request message is sent.

14. The method of claim 13, further comprising:
sending the request message using a first power level; and
resending the request message using a second power level, wherein the second power level is higher than the first power level.

15. A network node comprising
a processor and memory, wherein the processor and memory are configured to:
send, to a wireless transmit/receive unit (WTRU), configuration information for sounding reference signal (SRS) transmission, the configuration information comprising a power headroom (PH) threshold and an indication of a request resource;
receive, from the WTRU, a request message using the request resource, wherein the request message indicates that the a power headroom (PH) for the SRS transmission is greater than or less than a PH threshold;
send a response to the request message, wherein the response comprises an indication that one or more transmission parameters associated with the SRS transmission are to be modified.

16. The network node of claim 15, wherein the processor and memory are further configured to:
receive the SRS transmission using the one or more transmission parameters, wherein the one or more transmission parameters are modified in accordance with the indication comprised in the response.

17. The network node of claim 15, wherein the processor and memory are further configured to:
include, in the response to the request message, an indication that the WTRU is to cancel the SRS transmission.

18. The network node of claim 15, wherein the request message comprises a scheduling request.
